(19) United States
(12) Patent Application Publication
(10) Pub. No.: US 2002/0148339 A1
(43) Pub. Date: Oct. 17, 2002

(54) TRILATERAL CUTTER PARTICULARLY FOR TRIMMING THE EDGES OF BOOKS WITH A SIMPLIFIED BLADE CHANGE

(76) Inventor: ROBERTO ZECHINI, MILAN (IT)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/285,754

(22) Filed: Apr. 5, 1999

(30) Foreign Application Priority Data
Apr. 24, 1998 (IT) MI98A 000883

(51) Int. Cl. B26D 5/08

(52) U.S. Cl. 83/646; 83/934

(57) ABSTRACT

To simplify and reduce the necessary time of blade changing (4-6), every blade is attached to the connecting rods (15) which drive said blade without the interposition of a blade-holder. The setting of the cutting force with which each blade (4-6) presses on the counter-blade (7-9) is fixed by calibrating a maximum pressure hydraulic valve (30). In this way the cutting force exerted by each blade (4-6) does not exceed the optimal predefined maximum value for cutting all the sheets of paper, without damaging the counter-blades (7-9.

The present invention refers to a trilateral cutter, in particular for trimming the edges of books with a simplified blade change.

In the book-binding field, trilateral cutters are used to trim books. Such cutters are provided with blades which, at the end of the cutting run, come into contact with a counter-blade which substantially carries out a double function of supporting the trimmed edges of the book in the cutting stage and of blocking the blade. Clearly, the cutting run of the blade must be set in order to avoid that, after completion of the book cutting operation, the blade continues cutting into the counter-blade to the point of irreparable damage. To avoid this, the blade positions must be periodically adjusted (in particular, after each sharpening) in a very accurate way to compensate the position change of the new cutting edge with respects to the blade locking points on the cutter. With current cutters, the setting of each blade position is carried out with respects to its blade-holder which is then always fixed in the same position on the cutter. The positioning of the blade with respects to the blade-holder (which, as it has already been said, must be carried out with the utmost accuracy to avoid irreparable damage to the counter-blades) requires time and significant expertise while it is strongly desired to reduce said time and to simplify the operation in a way as to be able to confer this work to less qualified labour.

To reduce the trilateral cutter standstill time to a minimum (and therefore the operational expenses of said machine), mock-ups are actually being used through which the blade position in the corresponding blade-holder can be fixed with the required accuracy. In this way, during the blade change, the trilateral cutter is stopped only for the time needed to fix the blade-holder to the cutter itself. The operator carries out the delicate setting operation under optimal or ergonomically correct and safe conditions since said operator works outside of the cutter and is not pressed by time as the cutter is able to continue operating. The market development has nevertheless made said operating method susceptible to improvement. Therefore, it is still further required to reduce the inconvenience deriving from the need to set each blade position with respect to its blade-holder, since, even by using a mock-up, this operation is reliable only when it is carried out by skilled labour, as it is always necessary that the dimensional locking of each blade with respects to its blade-holder is carried out with the utmost accuracy in order to avoid that the cutting edge penetrates into the counter-blade thus irreparably damaging it or that the run is not deep enough to cut all the sheets of paper of the book.

Therefore, the purpose of the present invention is to make the setting and assembly of the blades less onerous, wherein said operation is necessary to obtain a correct cut of all the sheets of paper and to avoid, at the same time, an excessively long cutting operation that would damage the counter-blades.

Such a purpose is obtained by a trilateral cutter, in particular for trimming the edges of books, which comprises pressing means, operating means to move the three blades against the three corresponding counter-blades and setting means to bring the cutting of the edges to the requested size. The operating means of the three blades comprise three kinematic mechanisms essentially of the articulated quadrilateral type, each of which comprises a first and a second connecting rod. Each of said connecting rods has a first end hinged to a support structure which can be the pressing means or the cutter frame. Each of said connecting rods is simultaneously splined to a driving shaft rotated by at least one hydraulic cylinder. Preferably, there are two hydraulic cylinders: one for driving the two lateral blades while the other drives the transversal blade. The second end of said connecting rods is joined to the blade by a hinge. Said hydraulic cylinders which drive said connecting rods are part of a hydraulic system comprising at least one maximum pressure valve which is adjustable in function of the maximum pressure value of said hydraulic cylinder. The maximum pressure value is set in function of the cutting parameters by an electronic control unit that commands the inversion of the cutting movement when it reaches said value and therefore the predefined maximum cutting force that each blade exerts on the corresponding counter-blade. Therefore, in order to ensure that the cutting force which is exerted on the counter-blade is equal to the predefined maximum value, it is sufficient to chose an adequate pressure value to stop cutting, when said value has been reached.

Then, it is no longer necessary to attach, with micrometric accuracy, the blade to the connecting rods, by using, for instance, a blade-holder with adjustment means. In fact, independently of the position taken by the blade with respects to the kinematic mechanisms which moves said blade (i.e. the position of the cutting edge with respects to the kinematic mechanisms which moves the corresponding blade), the cutting operation is interrupted when the cutting force reaches the predefined maximum value which is in relation with the maximum operating pressure of the cylinder that moves the blade.

The basic idea of the present invention is opposite to the technical prejudices since it substantially eliminates the blade-holder as an element suitable to allow the setting of the position of the blade with respects to the kinematic mechanisms that operate said blade (or rather eliminates the blade-holder as an element suitable to allow the setting of the cutting edge position of the blade with respects to the kinematic mechanisms which moves the corresponding blade). The other innovation of the present invention is to operate the blade through a hydraulic actuator (preferably a hydraulic cylinder) and to give to an adjustable maximum pressure valve the task of operating in a way that the maximum cutting force that the blade exerts against the counter-blade at the end of its cutting run is less than a predefined limit value, in this way the blade presses against the counter-blade with a cutting force such as not to permanently cut into the counter-blade, however being sufficiently strong to properly cut every sheet of paper, even the last one which is directly positioned on the counter-blade. It is unessential to the present invention whether the cutter is equipped with just one maximum pressure valve or with a maximum pressure valve for every blade. The second solution has an advantage of automatically eliminating possible position differences of a blade with respects to the other blades when said blade meets the counter-blade since the maximum cutting force cannot exceed a determined maximum value equally set for all the blades. From what has been said above, it is understood that the use of a maximum pressure valve is clearly advantageous as it automatically eliminates, during cutting, every possible position differences of the cutting edges of the various blades, something which is not possible at the moment with any mechanical adjustment devices. A mechanical adjustment device is, in fact, always full of tolerance errors which can be reduced to a minimum only by very skilled labour but which can not be totally eliminated.

Another purpose of the present invention is to allow the blades cutting force to be adjusted without the need to remove said blades from the cutter, i.e. even during a work cycle of the cutter. From what has been said above, it can be clearly understood that the present invention considerably improves the working conditions in terms of physical fatigue, safety and the quality of the obtained results.

The invention is illustrated, by way of a non limiting example, in the attached figures which show one of the possible embodiments. The illustrated embodiment is substantially characterised by the reduced costs and by the reliability since its hydraulic circuit comprises just one maximum pressure valve that feeds both the hydraulic circuit that controls the two lateral blades and the hydraulic circuit that controls the transversal blade.

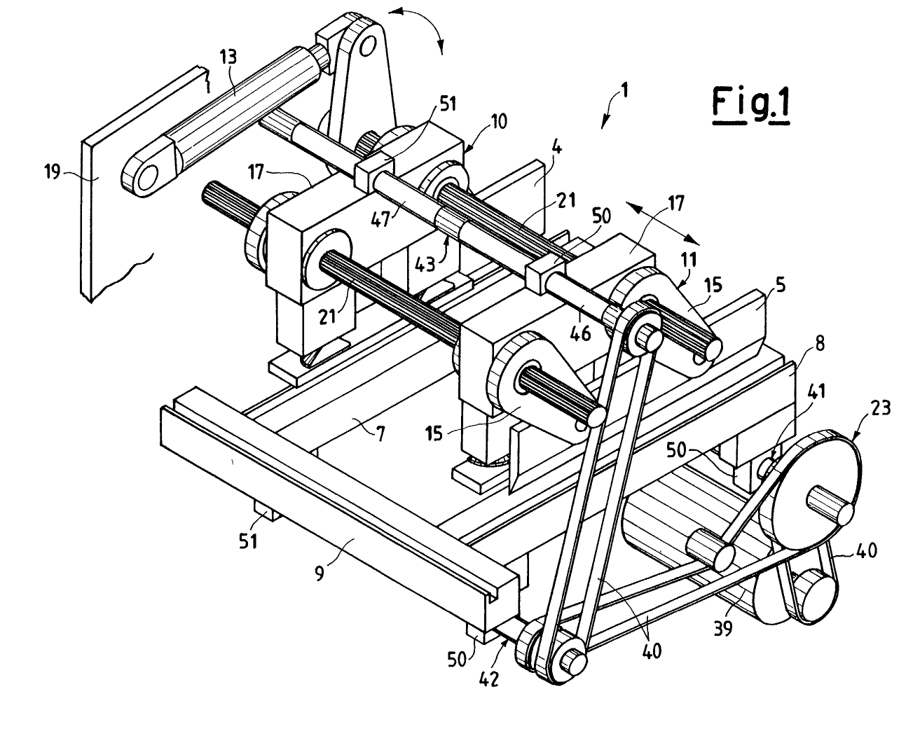

FIG. 1 is a partial perspective view of the cutter mechanism. In order not to confuse said figure, one of the three blades and the relevant operating kinematic mechanisms have not been illustrated.

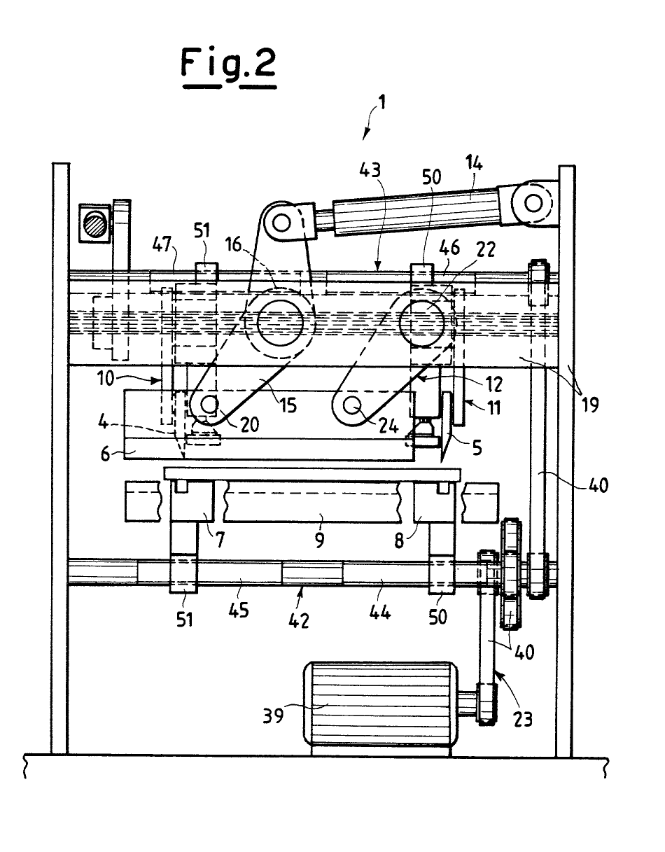

FIG. 2 is a front elevation view.

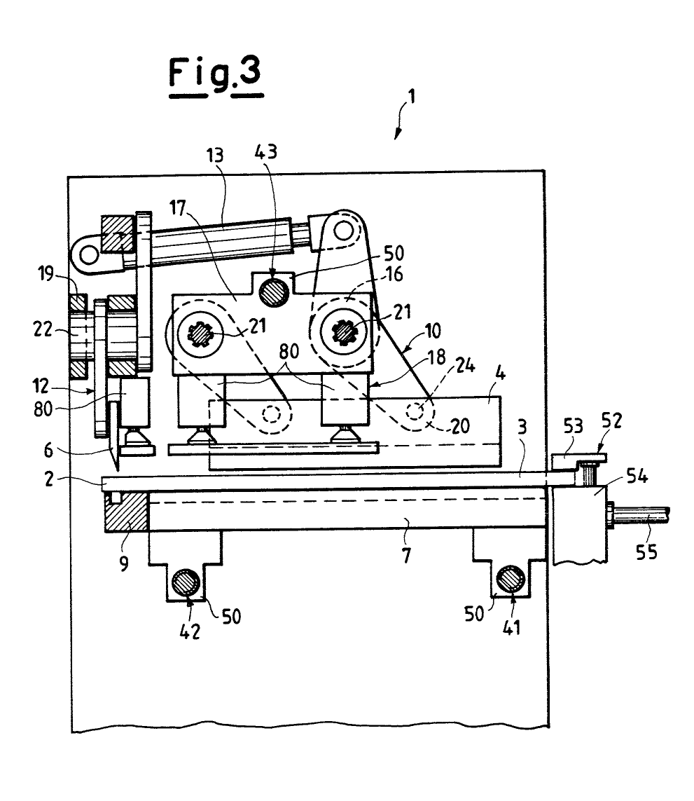

FIG. 3 is a cross-section view.

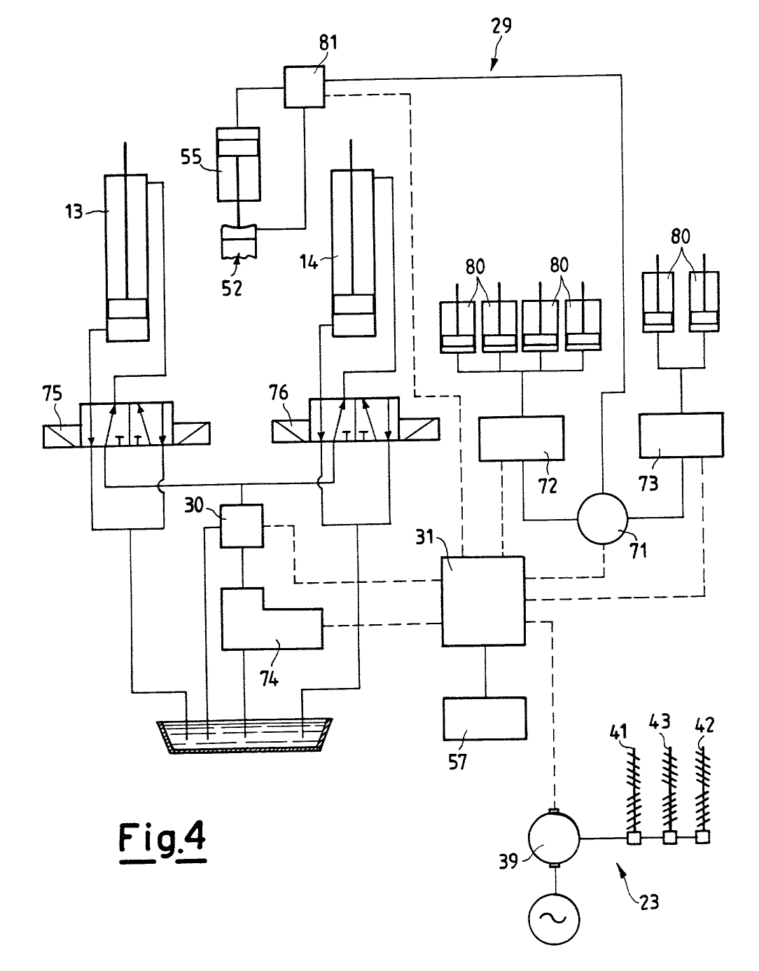

FIG. 4 is a block diagram of the hydraulic, pneumatic, electromechanical and electronic components of the cutter. In said figure the pressurised fluid (oil or air) flows are represented by a continuous line; the signal carrying elements are represented by a broken line.

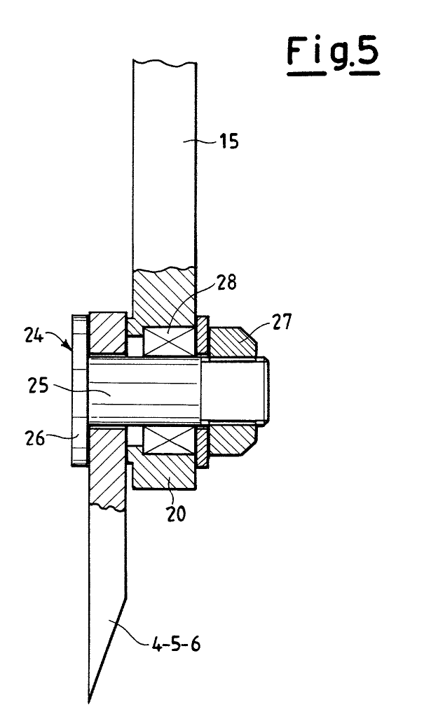

FIG. 5 shows the particular fixing of the connecting rod to the blade.

With reference to the above mentioned figures, the trilateral cutter, generically indicated by 1, is of the type which is particularly suitable for trimming the edges 2 of a book 3. Said cutter comprises pressing means, operating means of the first 4, the second 5 and the third 6 blade against the respective first 7, second 8 and third 9 counter-blade, setting means to bring the cutting of the edges 2 to the required size. The operating means of the three blades 4-6 essentially comprise a first 10, a second 11 and a third 12 kinematic mechanism all of the articulated quadrilateral type. The first 10 and the second 11 kinematic mechanisms are attached to the first 4 and to the second 5 blade (i.e. to the two lateral blades 4 and 5) and are moved by just one first hydraulic ram 13. The third kinematic mechanism 12 is attached to the third blade 6, which is the frontal one, and it is moved by a second hydraulic ram 14. Each kinematic mechanism 10-12 comprises a couple of connecting rods 15 wherein each one of said rods 15 has a first 16 and a second 20 end.

The first end 16 is hinged to a support structure. This support structure is the support structure 17 of the pressing means 18 in the case of the two lateral blades 4, 5 (i.e. first 4 and second 5), while it is the frame 19 of cutter 1 in the case of the third transversal blade 6. The first ends 16 of the connecting rods 15 are simultaneously splined to the first 21 and second 22 driving shafts. In view of the stresses which are supported by the shafts before being discharged onto the machine frame, the first spline shafts 21 are also supported, with respects to the frame 19 of the cutter, at the respective intermediate points. The first operating shafts 21 drive the connecting rods 15 of the first 10 and of the second 11 kinematic mechanisms, while the second operating shafts 22 drive the connecting rods 15 of the third kinematic mechanism 12.

The first operating shafts 21 are splined in a way to allow the connecting rods 15 to be positioned at will along said shafts 21 using the setting means to bring the cutting of the edges to the required size, generically indicated by 23. The connecting rods 15 of the third kinematic mechanism 12 are fixed to the second operating shafts 22. The second ends 20 of the connecting rods 15 are connected to the blades 4-6 by a second hinge 24. The preferred embodiment of the second hinge 24 is illustrated in FIG. 5. As it can be noticed, every second hinge 24 comprises a pin 25 provided, at one end, with a flange 26 and a threaded locking ring 27 at the other end. A bearing 28 is inserted between the pin 25 and the end 20 of the connecting rod 15. The first 13 and the second 14 hydraulic ram are part of a hydraulic-pneumatic-electric-electronic system, generically indicated by 29 and illustrated in FIG. 4. Said system 29 further comprises a hydraulic pump 74, a first 75 and a second 76 hydraulic distributor that feed said hydraulic rams 13 and 14 and at least one maximum pressure valve 30 set to work at the maximum operating pressure value of the hydraulic rams 13 and 14. The maximum operating pressure value of the hydraulic rams 13 and 14 is set as a function of the cutting parameters by an electronic control unit 31 that controls the inversion of the cutting movement, when said value is reached, i.e. when the predefined maximum cutting force, that each blade 46 exerts on the corresponding counter-blade 7-9, is reached. The maximum pressure valve 30 is adjustable in a way that the maximum cutting force that each of the three blades 4-6 exerts on the respective counter-blades is less than a predefined limit value in a way that every blade 4-6 presses every counter-blade 7-9 with a cutting force such as to not permanently cut into the counter-blades 7-9.

In this way, it is possible to simplify the cutter structure since the blades can be fixed directly to the connecting rods or to the machine, eliminating the traditional blade-holders provided with blade position adjustment means. Having at least one adjustable maximum pressure valve 30 allows three blade-holders and all the following adjustments to be eliminated. The micrometric accuracy of said adjustments influences the life of the cutting edge and/or the safeguard of the counter-blade which comes into contact with said cutting edge. When the predefined maximum pressure is reached, at the end of the cutting operation, the electronic control unit 31 switches the position of the distributors 75 and 76 thus bringing the blades of the cutter back to the starting position ready for a new cutting cycle. The electronic control unit 31 further comprises a keyboard 57 through which it is possible to easily input any data of the desired size dimensions in a way that, by using the setting means 23, the cutter 1 is automatically prepared, in real time, to cut the book according to the programmed new size dimensions. The setting means 23, used to bring the cutting of the edges to the required size, comprise: a first 41, a second 42 and a third 43 nut, each of said nuts 41-42 comprises a first section 44 threaded in one direction and a second section 45 threaded in the opposite direction. The nut 43 comprises a first section 46 threaded as in 44 and a second section 47 threaded as in 45. The sections 44 and 46 are threaded in one direction and engage with the first three nut screws 50 threaded in the same direction. The sections 45 and 47 threaded in the opposite direction engage with the second three nut screws 51 threaded in the same direction. The first three nut screws 50 are integral to the second counter-blade 8 and to the support structure 17 of the pressing means of the second blade 5. The second nut screws 51 are integral to the first counter-blade 7 and to the support structure 17 of the pressing means of the first blade 4. In order to motorise and therefore make the use of cutter 1 easier and quicker, the setting means 23 comprise a third driving element 39 which drives, through a transmission 40, the first 41, the second 42 and the third 43 nut. To obtain a compromise between the costs and the noiselessness of this realisation, the transmission 40 is of the belt type. As it is shown in FIG. 1, said belt transmission comprises a plurality of belts and of corresponding pulleys.

The pressing means 18 comprise motor means or pneumatic pistons 80 which are supplied with compressed air produced by a source 71 conveniently intercepted by a second 72 and a third 73 pneumatic distributor driven by the electronic control unit 31.

Always to make the use of cutter 1 easier and quicker, said cutter 1 also comprises positioning means for the book 3 between the three blades 4-6 (of the non-manual type). The positioning means for book 3 between the three blades 4-6 comprise an air-gun 52, between which jaws 53 and 54 the book 3 is clamped. The air-gun 52 is attached to a fourth driving element 55 (which, in the example, is a pneumatic cylinder) which moves said airgun longitudinally along longitudinal guides in function of a first pneumatic distributor 81 which is driven by the electronic control unit 31. In this way the book is initially placed in the working area of the first two blades 4, 5 and, after the completion of the cutting operation, it is pushed in the working area of the third blade 6.

In short, the way the cutter works is the following. Once the size dimensions have been decided, they are entered, using keyboard 57, into the electronic control unit 31 which memorises them and which controls the setting means 23 in a way to change the position of the first 4 and the second 5 blade and of the respective first 7 and second 8 counter-blade and the pressing devices 18. No setting is provided for the third blade 6, the third counter-blade 9 and for the related pressing means. However, the extent of the longitudinal movements of the airgun (and in particular the second longitudinal movement) is programmed in function of the given dimensions. The book 3 is placed in the working area of air-gun 52 which clamps said book. The fourth driving element 55 works by making airgun 52 and book 3 carry out a longitudinal movement which takes the book to the working area of the first blade 4 and of the second blade 5. The first blade 4 and the first blade 5 operate by simultaneously trimming the two opposed edges 2 of the book 3. The airgun 52 carries out a second longitudinal movement and places the book in the working area of the third blade 6 that trims also the third edge of the book 3. The jaw 52 continues its longitudinal movement to eject the trimmed book 3 from the cutter and, for instance, to place said book on a contiguous belt carrier.

The trimming operation can be continuously carried out and, by programming and/or by properly operating the electronic control unit 31, it is also possible to process different size books, since the time needed to prepare the machine is just the time needed to programme the electronic control unit.

The removal of blades 4-6 is easy and practically immediate since it is sufficient to remove the pins 25.

The operations are reversed in order to install the blades 4-6. There are no adjustments needed for the machine since, during the cutting operation, the cutting force is controlled hydraulically, in a way that it reaches, but does not exceed, a predetermined value sufficient to properly perform the cutting operation without damaging the counter-blades.

1. A trilateral cutter (1), in particular for trimming the edges (2) of a book (3), with a simplified blade (46) change comprising pressing means (18), operating means to move the three blades (4-6) against the respective three counter-blades (7-9), adjustment means in order to bring the cutting of the edges (2) to the required size, characterised in that the operating means of the three blades (4-6) comprise three articulated quadrilateral kinematic mechanisms (10-12), each one of said mechanisms comprises a couple of connecting rods (15), each of said connecting rods (15) has a first end (16) hinged to a support structure (17, 19) and is simultaneously splined to an operating shaft (21, 22) driven to rotate by at least one hydraulic cylinder (13, 14) and the second end (20) is connected to the blade (4-6) by a hinge (24), wherein said hydraulic cylinder (13, 14) is part of a hydraulic system (29) comprising at least one maximum pressure valve (30) set to work at the maximum operating pressure value of said hydraulic cylinder (13, 14), said value being set to work in function of the cutting parameters by an electronic control unit (31) that controls the inversion of the cutting movement when said value is reached i.e. when the predefined maximum cutting force, that each blade (4-6) exerts on the corresponding counter-blade (7-9), is reached.

2. A trilateral cutter as claimed in claim 1, characterised in that the second ends (20) of the connecting rods (15) are connected to the blades (4-6) by the second hinges (24).

3. A trilateral cutter as claimed in claim 2, characterised in that the second hinges (24) comprise a pin (25) provided, at one end, with a flange (26) and with a threaded locking ring (27) at the other end.

4. A trilateral cutter as claimed in claim 3, characterised in that a bearing (28) is put between the pin (25) and the second end (20) of the connecting rod (15).

5. A trilateral cutter as claimed in claim 1, characterised in that the setting means (23), which bring the cutting of the edges to the required size, comprise: a first (41), a second (42) and a third (43) nut, each of said nuts (41-43) comprises a first section (44, 46) threaded in one direction and a second section (47, 49) threaded in the opposite direction, said first three sections (44, 46) threaded in one direction engage with the first three nut screws (50) threaded in the same direction, said second sections (47, 49) threaded in the opposite direction engage with the second three nut screws (51) threaded in the same direction, said first three nut screws (50) are integral to the second counter-blade (8) and to one of the support structures (17) of the pressing means (18), said second nut screws (51) are integral to the first counter-blade (7) and to the remaining structure support (17) of the pressing means (18).

6. A trilateral cutter as claimed in claim 1, characterised by comprising positioning means of the book (3) between the blades (4-6).

7. A trilateral cutter as claimed in claim 6, characterised in that the positioning means of the book (3) between the three blades (4-6) comprise an air-gun (52) wherein the book (3) is clamped between the jaws (53, 54) of said air-gun, which is attached to a fourth driving element (55) which moves said air-gun longitudinally along longitudinal guides.

8. A trilateral cutter as claimed in claim 1, characterised in that the first (13) and the second (14) hydraulic ram are part of a hydraulic system that further comprises a hydraulic pump (74), a first (75) and a second hydraulic distributor (76) and a maximum pressure valve (30) adjustable in such a way that the maximum cutting force that each of the three blades (46) exerts on the respective counter-blades (7-9) is less than the predefined limit value, so that every blade (46) presses against every counter-blade (7-9) with a cutting force such as not to permanently cut into the counter-blades (7-9).
